(19) United States
(12) Patent Application Publication
(10) Pub. No.: US 2015/0204490 A1
(43) Pub. Date: Jul. 23, 2015

(54) PRINTED LED LAYER WITH DIFFUSING DIELECTRIC AND CONDUCTOR LAYERS

(71) Applicant: Nthdegree Technologies Worldwide Inc., Tempe, AZ (US)

(72) Inventors: Lixin Zheng, Kirkland, WA (US); Alexander Ray, Tempe, AZ (US); Jeffrey Baldridge, Chandler, AZ (US)

(73) Assignee: Nthdegree Technologies Worldwide Inc., Tempe, AZ (US)

(21) Appl. No.: 14/259,978

(22) Filed: Apr. 23, 2014

Related U.S. Application Data
(60) Provisional application No. 61/929,028, filed on Jan. 18, 2014.
(60) Provisional application No. 61/933,652, filed on Jan. 30, 2014.
(60) Provisional application No. 61/933,617, filed on Jan. 30, 2014.

(51) Int. Cl. F21K 99/00

(52) U.S. Cl. CPC F21K 9/50

(57) ABSTRACT

In one embodiment, a flexible light sheet includes a transparent, thin polymer substrate on which is formed a dielectric first light scattering layer containing nano-particles. A transparent conductor layer is formed over the first light scattering layer. An array of microscopic, inorganic vertical LEDs is printed over the transparent conductor layer so that bottom electrodes of the LEDs make electrical contact to the conductor layer. A dielectric second light scattering layer, also containing the nano-particles, is printed over the transparent conductor layer to laterally surround the LEDs. A top conductor layer makes electrical contact to the top LED electrodes to connect the LEDs in parallel. Light from the LEDs is scattered by the nano-particles in the two light scattering layers by Mei scattering. This reduces total internal reflection in both the first light scattering layer and the transparent conductor layer to increase light extraction.

### CROSS-REFERENCE TO RELATED APPLICATIONS

This application is based on U.S. provisional application Ser. Nos. 61/929,028, filed Jan. 18, 2014, by Lixin Zheng et al.; 61/933,652, filed Jan. 30, 2014, by Lixin Zheng et al.; and 61/933,617, filed Jan. 30, 2014, by Lixin Zheng et al., all applications being assigned to the present assignee and incorporated herein by reference.

### FIELD OF THE INVENTION

This invention relates to forming a light emitting diode (LED) lamp and, in particular, to forming an LED light sheet with an array of LEDs and light diffusing layers to reduce wave-guiding and TIR to increase light extraction.

### BACKGROUND

It is known, by the present assignee's own work, how to form and print microscopic vertical light emitting diodes (LEDs), with the proper orientation, on a conductive substrate and connect the LEDs in parallel to form a light sheet. Details of such printing of LEDs can be found in U.S. application publication U.S. 2012/0164796, entitled, Method of Manufacturing a Printable Composition of Liquid or Gel Suspension of Diodes, assigned to the present assignee and incorporated herein by reference.

FIG. 1 is a cross-sectional view of a layer of LEDs 16 that may be printed using the following process. Each LED 16 includes standard semiconductor GaN layers, including an n-layer, and active layer, and a p-layer.

An LED wafer, containing many thousands of vertical LEDs, is fabricated so that the bottom metal cathode electrode 18 for each LED 16 includes a reflective layer. The top metal anode electrode 20 for each LED 16 is small to allow almost all the LED light to escape through the anode surface and the side walls. A carrier wafer, bonded to the “top” surface of the LED wafer by an adhesive layer, may be used to gain access to both sides of the LED for metallization. The LEDs 16 are then singulated, such as by etching trenches around each LED down to the adhesive layer and dissolving the exposed adhesive layer or by thinning the carrier wafer. The LEDs have a hexagonal shape.

The microscopic LEDs are then uniformly infused in a solvent, including a viscosity-modifying polymer resin, to form an LED ink for printing, such as screen printing or flexographic printing.

If it is desired for the anode electrodes 20 to be oriented in a direction opposite to the substrate 22 after printing, the electrodes 20 are made tall so that the LEDs 16 are rotated in the solvent, by fluid pressure, as they settle on the substrate surface. The LEDs 16 rotate to an orientation of least resistance. Over 90% like orientation has been achieved.

In FIG. 1, a starting substrate 22 is provided. If the substrate 22 itself is not conductive, a reflective conductor layer 24 (e.g., aluminum) is deposited on the substrate 22 such as by printing. In another embodiment, a reflective film is laminated on the substrate 22 and a transparent ITO conductive layer serves as the conductor layer 24. The substrate 22 may be thin and flexible.

The LEDs 16 are then printed on the conductor layer 24 such as by flexography, where a pattern on a rolling plate determines the deposition of LED ink for a roll-to-roll process, or by screen printing with a suitable mesh to allow the LEDs to pass through and control the thickness of the layer. Because of the comparatively low concentration of LEDs 16 in the ink, the LEDs 16 will be printed as a monolayer and be fairly uniformly distributed over the conductor layer 24. Thousands of LEDs are typically printed for a single light sheet.

The solvent is then evaporated by heat using, for example, an infrared oven. After curing, the LEDs 16 remain attached to the underlying conductor layer 24 with a small amount of residual resin that was dissolved in the LED ink as a viscosity modifier. The adhesive properties of the resin and the decrease in volume of resin underneath the LEDs 16 during curing press the bottom LED electrode 18 against the underlying conductor 24, making electrical contact with it.

A transparent homogeneous dielectric layer 26 is then printed over the surface to encapsulate the LEDs 16 and further secure them in position.

A top transparent conductor layer 28 is then printed over the dielectric layer 26 to electrically contact the electrodes 20 and is cured in an oven appropriate for the type of transparent conductor being used.

A layer of phosphor may be deposited over the surface of the light sheet to convert some of the blue LED light to, for example, yellow light to create an overall white light emission.

The present inventors have discovered that there is significant wave-guiding of light in the transparent dielectric layer 26 due to a high percentage of the light from the LEDs 16 being emitted at low angles relative to the dielectric layer 26 surfaces. Such wave-guiding is due to total internal reflection (TIR) as a result of the different indices of refraction (n) of materials at the interfaces. Such internally reflected light can become trapped in the layer and significantly attenuate the light due to all the internal reflections. A trapped light ray 29 is shown in the dielectric layer 26. The inventors have found that 70-80% of the light generated by the LEDs 16 remains confined in the light sheet. Therefore, reducing this percentage will increase the light extraction efficiency of the light sheet.

Additionally, even when light exits through the dielectric layer 26 and enters the transparent conductor layer 28, much of the light reflects off the top surface of the layer 28 by TIR, such as light ray 30, due to the difference in indices of refraction of the two mediums at the interface. Above the transparent conductor layer 28 may be air, a phosphor layer, an encapsulant, or other layer.

What is needed is a technique to improve the light extraction of a light sheet similar to that of FIG. 1 using a transparent dielectric layer and a transparent conductor layer.

### SUMMARY

In one embodiment, the dielectric layer of FIG. 1 is formed as a mixture of a transparent polymer binder and dielectric micro-particles or nano-particles to form a diffuser. The sizes of the diffusive particles, such as spheres, are on the order of the peak wavelength of light emitted by the printed LEDs to achieve Mei scattering by the particles. Mei scattering is most efficient when the particle size equals the wavelength of incident light; however, the size of the particles may be greater than or less than the incident light wavelength and still exhibit Mei scattering. The indices of refraction of the binder (e.g., n about 1.4-1.6) and the particles are different to cause the particles to scatter the LED light by Mei scattering so that the light is more likely to escape the dielectric layer without any internal reflection at the interfaces or with only a few internal reflections. Such particles include TiO2 (n about 2.6) or other dielectric particles, such as polymer spheres. The percentage by weight (e.g., up to 15% for TiO2 and up to 70% for polymer spheres) depends on the desired diffusivity.

To mitigate the problem with TIR in the transparent conductor layer, another light diffusive layer is printed over the transparent conductor layer. The diffusive layer contains dielectric nano-particles, such as TiO2 or polymer spheres, in a transparent binder. The difference in the indices of refraction between the binder and the particles is relatively high to obtain a high degree of Mei scattering.

If the LED light is to exit through the transparent substrate, then the diffusive layer is printed between a transparent conductor layer and the substrate.

Even when there is TIR at an interface of two different materials, the light penetrates a few hundred nanometers beyond the interface before being reflected. This distance is called the near-field. The nano-particles in the diffusive layer adjacent the transparent conductor layer are located within the near-field so that these particles in the near field scatter light. This results in even shallow light rays being extracted from the transparent conductor layer when the light rays impact a particle in the diffusive layer. Without the diffusive layer, those light rays within the transparent conductor layer may internally reflect.

In one embodiment, the transparent conductor layer contains silver nano-wires in a solvent (e.g., isopropyl alcohol), forming a printable ink. When the layer is cured, the solvent evaporates and the overlapping silver nano-wires are sintered together to form a 3-dimensional wire mesh within a thin transparent binder layer. The transparency of the conductor layer is preferably optimized by using relatively long and narrow nano-wires. The wire mesh somewhat diffuses the light that enters the conductor layer, which is desirable. The conductor layer is also flexible. As an example, the silver nano-wire layer used as a transparent conductor includes silver nano-wires having diameters of 60-130 nm and lengths 15-25 um. The density of the nano-wires in the ink results in the cured layer to have an average nano-wire pitch of about 500-1000 nm. This results in over 90% transmittance with a sheet resistance of about 6.5 ohms/sq.

The bottom cathode electrodes of the LED are reflective as well as the bottom conductor layer or the substrate, so any diffusing of light back towards the LED layer will be reflected upward and exit the light sheet.

If the light is to exit through the substrate, the top electrodes of the LEDs are reflective, there is a reflective layer over the LEDs, and the transparent conductor layer is between the transparent substrate and the LED layer.

Accordingly, since the dielectric layer around the LEDs is diffusive and the transparent conductor layer is sandwiched between two diffusive layers, TIR and wave-guiding is reduced and more light escapes the light sheet to increase its efficiency.

The substrate may include optical features, such as molded prisms, or a roughened surface, or light scattering particles to reduce TIR and wave-guiding within the substrate.

The light sheet may also be bi-directional, with both conductor layers being transparent. In such an embodiment, a diffusive layer abuts each of the transparent conductor layers.

Variations of the above embodiments are contemplated.

### BRIEF DESCRIPTION OF THE DRAWINGS

FIG. 1 is a cross-section of a prior art light sheet previously invented by the present assignee, with an array of vertical LEDs sandwiched between two conductor layers to connect the LEDs in parallel, where there is significant wave-guiding in the dielectric layer and TIR off the top transparent conductor layer.

FIG. 2 is a cross-section of a light sheet in accordance with one embodiment of the invention, where the dielectric layer is made to be diffusing and another diffusive layer is provided over the transparent conductor layer to reduce TIR and increase light extraction.

FIG. 3 is a top down view of the light sheet of FIG. 2 showing only a few LEDs, greatly enlarged relative to the light sheet.

FIG. 4 is a cross-section of a light sheet where the light is emitted downward through a transparent or diffusing substrate, where the dielectric layer is made to be diffusing, and another diffusive layer is provided below the transparent conductor layer to reduce TIR and increase light extraction.

FIG. 5 is a flowchart identifying various steps used to form the structure of FIG. 4 using a silver nano-wire conductor layer.

Elements that are similar or identical in the various figures are labeled with the same numeral.

### DETAILED DESCRIPTION

FIG. 2 illustrates one embodiment of the invention, showing only a very small part of a light sheet 31. The substrate 22 may be a thin polycarbonate film or any other material, such as PET, PEN, a flexible glass, a metal, or any polymer. The substrate 22 may be dispensed in a roll-to-roll process for fabricating the light sheet 31 since all deposition steps may be by printing at atmospheric pressures.

If the substrate 22 is not conductive, a conductor layer 24, such as aluminum, is deposited on the substrate 22 such as by printing and curing an aluminum ink. In another embodiment, a reflective film is laminated over the substrate 22, and a transparent conductor layer is printed over the reflective layer, such as a silver nano-wire layer or ITO.

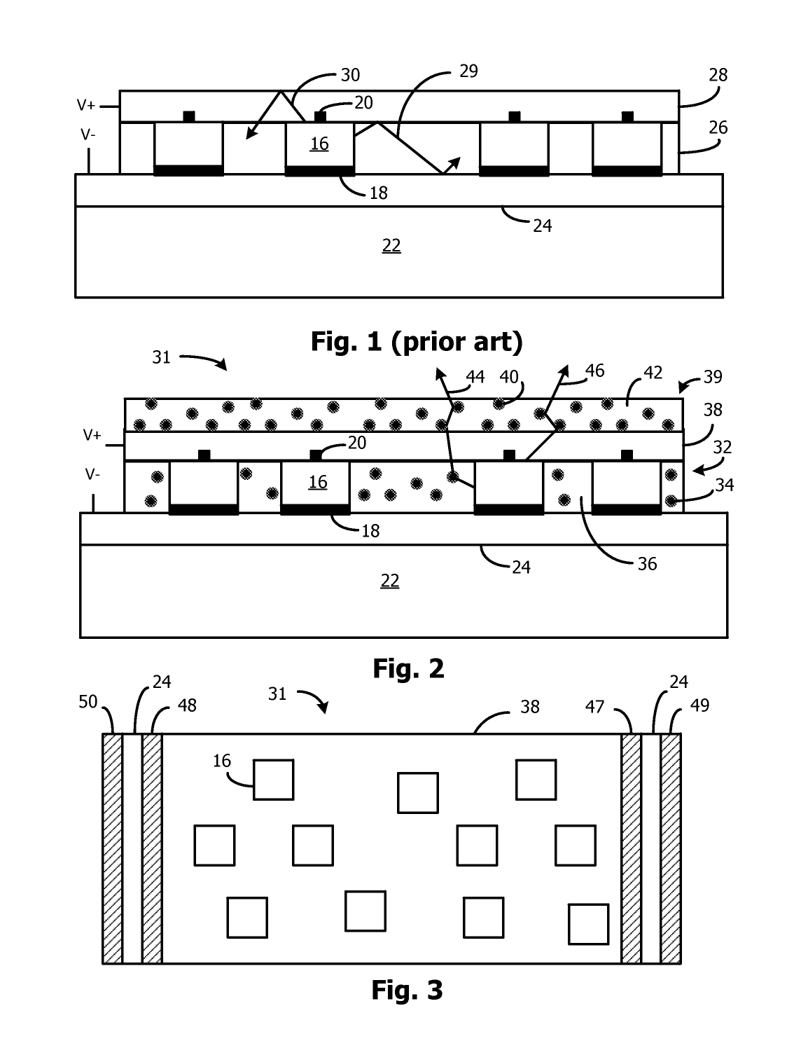

An LED ink is prepared, as described with respect to FIG. 1, comprising microscopic vertical LEDs 16, a solvent, and a viscosity-modifying resin. The LEDs 16 are then printed by screen printing, flexography, or using other methods. The ink is then cured, and the bottom reflective electrodes 18 of the LEDs 16 make electrical contact to the conductor layer 24.

The GaN-based micro-LEDs used in embodiments of the present invention are less than a third the diameter of a human hair and less than a tenth as high, rendering them essentially invisible to the naked eye when the LEDs are sparsely spread across a substrate to be illuminated. The number of micro-LED devices per unit area may be freely adjusted when applying the micro-LEDs to the substrate. A well dispersed random distribution across the surface can produce nearly any desirable surface brightness. Lamps well in excess of 10,000 cd/m² have been demonstrated by the assignee. The LEDs 16 includes standard semiconductor GaN layers, including an n-layer, and active layer, and a p-layer.

The LEDs 16 may instead be formed using many other techniques and may be either much larger or smaller. The lamps described herein may be constructed by techniques other than printing.

A dielectric mixture is made including a transparent dielectric binder, such as an acrylic or silicone, and light scattering dielectric particles. The binder will typically be a curable polymer that can be printed. The particles are micro-particles or nano-particles. The sizes of the diffusive particles are preferably about the size of the peak wavelength of light emitted by the printed LEDs (blue light is between 450-500 nm) to optimize Mei scattering. In Mei scattering, due to the sizes of the particles being about the size of the light wavelength, the particles interact with the light waves to scatter (i.e., diffuse) the light over a wide angle. Such Mei scattering occurs naturally in air to scatter sunlight. Mei scattering is unrelated to refraction of light (or TIR) at the smooth interface of unmatched materials where no small particles are involved, and such conventional refraction does not scatter or diffuse light but just changes the angle of light rays. Therefore, the sizes of the particles must be very small to achieve Mei scattering. The particles have an index of refraction (n) that is different from the index of the binder so that visible light scatters at the interface of the binder and particles due to the Mei scattering. The indices of refraction of the particles and the binder are preferably as close to unity as practical. Suitable particles include titanium oxide (TiO2), which are commercially available in a variety of dimensions and have a high index of about 2.6, and polymer or glass spheres having a range of indices between about 1.4-1.7. Spheres may optimize the Mei scattering. A polymer binder material is selected to have a different index. Polymers with selectable indices are commercially available.

For TiO2 or other high refractive index metal oxides, particle sizes between 200 nm to 1 um for blue LED light are adequate, and particles having diameters of about 450-500 nm are preferred.

For the lower index polymer spheres, particles sizes between 300 nm to 1 um for blue LED light are adequate, and particles having diameters of about 450-500 nm are preferred. For the diffusive layer 39 or 65, polymer sphere diameters of up to 10 um may be used, but the performance is not optimal.

The particles in the diffusive layer 32 may be the same as or different from the particles in the diffusive layers 39 and 65.

The percentage by weight of the nano-particles may be 5-15% for TiO2 particles and up to 70% for polymer particles. The thickness of the dielectric layer will also determine the required percentage by weight of the particles, where a thicker dielectric layer will require a lower percentage since the likelihood of a light ray being scattered by a particle increases with the dielectric layer thickness.

The diffusion property of the dielectric layer 32 is defined by “mean free path.” The mean free path is the average distance travelled by a moving photon between successive impacts with particles 34, where the impact modifies its direction. In an optical model of the embodiment of FIG. 2, if the mean free path in the dielectric layer 32 equals 0.14×layer thickness, the light extraction efficiency will be doubled compared with using the prior art non-diffusive dielectric layer of FIG. 1. So preferably, the particles 34 in the dielectric layer 32 are selected to provide a mean free path in the range of 0.05-0.3×layer thickness. The average refractive index of the dielectric layer will typically range from 1.4 to 1.8.

The dielectric mixture is then printed over the LED layer so that the dielectric layer 32 does not cover the top electrodes 20 of the LEDs 16. The dielectric material wicks off or pulls away from the tops of the electrodes 20 by surface tension. The nano-particles 34 and transparent binder 36 are shown in FIG. 2. The maximum thickness of the dielectric layer 32 depends on the heights of the LEDs 16 and will typically be between 10-100 microns, and only about 10 microns in a practical embodiment using printed inorganic LED dies.

A printable transparent conductor material is then printed over the dielectric layer 32 to electrically contact the top electrodes 20 of the LEDs 16. The material is preferably silver nano-wires in a solvent, such as isopropyl alcohol.

The silver nano-wire transparent conductor layer 38 is very thin and transparent and includes silver nano-wires having diameters of 60-130 nm and lengths 15-25 um. Such dimensions of the nano-wires are optimized for creating a randomly orientated mesh of the nano-wires that somewhat overlap but leave relatively large openings between the nano-wires. The deposited conductive layer is heated to evaporate the solvent and sinter the nano-wires where they overlap to create a conductive wire mesh in three dimensions. The density of the nano-wires in the cured layer typically causes the layer to have an average nano-wire pitch of between 500-1000 nm. This results in over 90% transmittance with a sheet resistance of about 6.5 ohms/sq. There is some scattering of light by the wire mesh.

Other printable transparent conductor materials can be used; however, a silver nano-wire ink is particularly attractive due to its transparency and its mechanical flexibility.

The LEDs 16 are thus connected in parallel.

A diffusive layer 39 is then printed over the transparent conductor layer 38. The diffusive layer 39 may be the same material that forms the dielectric layer 32. The layer 39 has dielectric nano-particles 40 (e.g., TiO2 or polymer spheres) in a dielectric polymer binder 42. The indices of refraction of the particles 40 and binder 42 are different, and the particles 40 are on the order of the wavelength of the LED light (e.g., 450-500 nm for blue light) to achieve Mei scattering.

Since the particles 40 are throughout the layer 39, even within the near field region, most of the light that reaches the top surface of the transparent conductor layer 38 will scatter due to the particles 40 near the interface and not be reflected back into the transparent conductor layer 38. Thus, TIR off the top surface of the transparent conductor layer 38 is greatly reduced to increase light extraction.

The thickness of the diffusive layer 39 is not particularly important, since the density of the particles and the likelihood of a light ray being incident on a particle is most relevant to achieve the desired Mei scattering effect.

When a suitable voltage is applied across the transparent conductor layer 38 and the bottom conductor layer 24, the LEDs 16 are forward biased and light is emitted from the top and sides of the LEDs 16 at a wide variety of angles. Some light passes directly through the dielectric layer 32 and transparent conductor layer 38, but other light rays, typically at low angles, have a high probability of being scattered by the particles 34 and 40 in the diffusive layers 32 and 39 and then exiting the light sheet without TIR. Accordingly, light will not be trapped in the layers, and light extraction is increased.

In FIG. 2, a light ray 44 is shown being scattered by particles 34 and 40 in the layers 32 and 39. Actually, light is scattered in all directions by the particles 34/40. A light ray 46 is also show being emitted from the top surface of an LED die directly into the transparent conductor layer 38 and scattered by a particle 40.

A top phosphor layer (not shown) may be printed over the diffusive layer 39 for wavelength-conversion of some or all of the LED light. Typically, the phosphor layer would include YAG phosphor, where blue light leaking though the phosphor layer and the yellow phosphor light creates white light.

FIG. 3 shows a possible top down view of the light sheet 31 of FIG. 2, where only a few greatly enlarged LEDs 16 are shown. The diffusive layer 39 is not shown. The transparent conductor layer 38 has metal bus bars 47 and 48 printed along its edges for being connected to a power supply and conducting the current across the layer 38. The bottom conductor layer 24 extends beyond the layer 38 and is also contacted with metal bus bars 49 and 50 for being connected to the power supply and conducting the current across the layer 24.

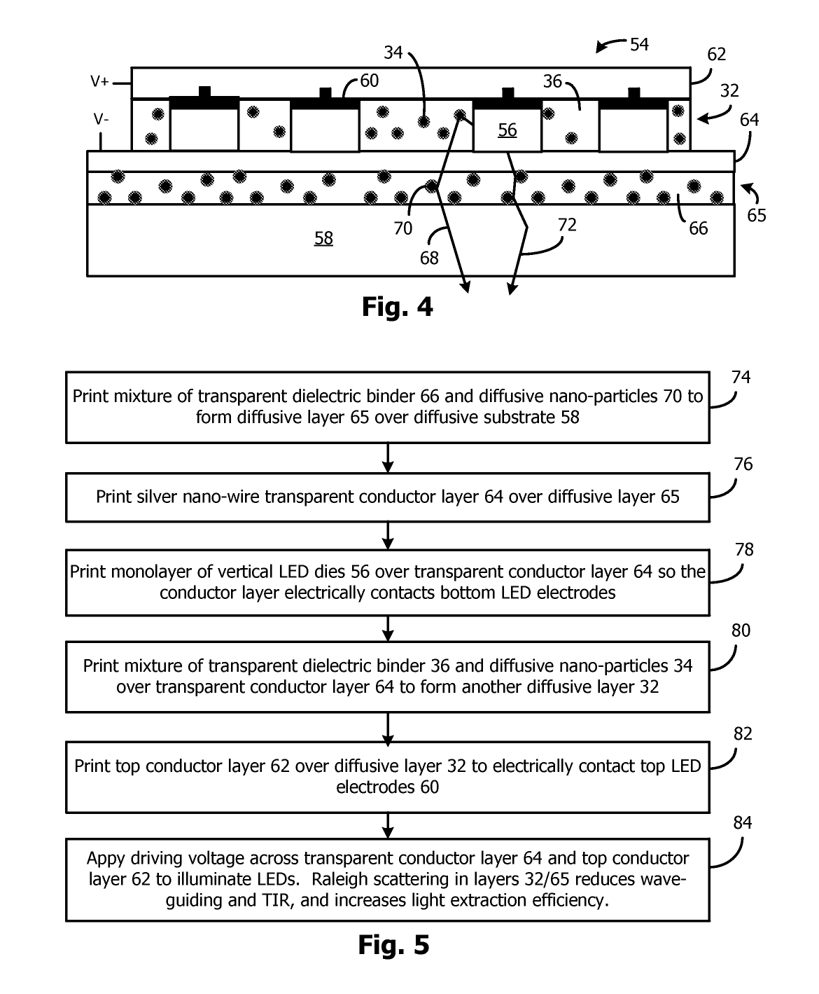

FIG. 4 illustrates a light sheet 54 where the light from the LEDs 56 is directed downward through the transparent substrate 58. The LEDs 56 have a large reflective top electrode 60 and a small or transparent bottom electrode. The top conductor layer 62 can be reflective, or the top conductor layer 62 may be transparent and a separate mirror layer is deposited over the top conductor layer 62.

The dielectric layer 32 may be identical to that shown in FIG. 2.

The bottom conductor layer 64 may be the transparent silver nano-wire layer previously discussed with respect to FIG. 2. The dielectric diffusive layer 65 may be the same material as the diffusive layer 39 shown in FIG. 2 formed by a transparent binder 66 and nano-particles 70 to achieve Mei scattering.

The substrate 58 may be a flexible thin film having optical features formed in to prevent wave-guiding of light within the substrate 58. The substrate 58 may be a transparent film, such as polycarbonate or PET, with small prisms formed in its bottom surface or top surface to scatter the light to minimize TIR. The surface may instead be randomly roughened. Alternatively, dielectric nano-particles, such as the TiO2 or polymer spheres discussed above, may be incorporated in the substrate 58 for scattering light using Mei scattering.

A light ray 68 is shown being scattered (by Mei scattering) by a nano-particle 34 in the dielectric layer 32 and by a nano-particle 70 in the diffusive layer 65. Another light ray 72, emitted from the bottom surface of the LED 56, is scattered by two nano-particles 70 in the diffusive layer 65 and further scattered by an optical feature, such as a nano-particle, in the substrate 58.

The combined transmittance of all the layers that light passes through is preferably greater than 70%.

A phosphor layer may be deposited on the bottom surface of the substrate 58 to create white light.

If a bi-directional light sheet is desired, the top and bottom electrodes of the LEDs would allow light to exit through both surfaces, and the conductor layers and substrate would be transparent. The diffusive layers would be provided abutting both transparent conductor layers to minimize TIR and maximize light extraction.

To further increase light extraction, the light emitting surfaces of the LEDs may be roughened.

The light sheets described herein may be less than 1 mm thick and fabricated using a roll-to-roll process, where all the materials are printed and cured at atmospheric pressures.

FIG. 5 is a flowchart summarizing the steps used to form the light sheet of FIG. 4. In step 74, the diffusive layer 65 is printed over the diffusive substrate 58.

In step 76, a silver nano-wire ink is printed and cured to form the transparent conductor layer 64.

In step 78, a monolayer of LEDs 56 is printed over the transparent conductor layer 64 so that the bottom LED electrodes make electrical contact with the transparent conductor layer 64.

In step 80, the diffusive dielectric layer 32 is printed over the transparent conductor layer 64,.

In step 82, the top conductor layer 62 is printed over the dielectric layer 32 to electrically contact the top electrodes 60 of the LEDs 56.

In step 84, a driving voltage is applied across the two conductor layers to turn on the LEDs 56. The nano-particles in the layers scatter (i.e., diffuse) the light by Mei scattering to reduce TIR and wave-guiding and increase light extraction efficiency.

While particular embodiments of the present invention have been shown and described, it will be obvious to those skilled in the art that changes and modifications may be made without departing from this invention in its broader aspects and, therefore, the appended claims are to encompass within their scope all such changes and modifications as fall within the true spirit and scope of this invention.

What is claimed is:

1. An illumination structure comprising:
a substrate;
a first conductive layer;
an array of vertical light emitting diodes (LEDs) provided over the substrate so that first electrodes of the LEDs make electrical contact to the first conductive layer;
a first diffusive dielectric layer formed around the LEDs, the first diffusive dielectric layer comprising a first transparent binder, having a first index of refraction, and first diffusive particles having sub-micron dimensions, the first diffusive particles having a second index of refraction different from the first index of refraction so that, when the LEDs are illuminated, some light from the LEDs is scattered by the first diffusive particles by Mei scattering, causing the first diffusive dielectric layer to be diffusive to light emitted by the LEDs;
a second conductive layer, allowing light from the LEDs to pass through, making electrical contact to second electrodes of the LEDs and connecting the LEDs in parallel; and
a second diffusive dielectric layer abutting the second conductive layer, the second diffusive dielectric layer comprising a second transparent binder, having a third index of refraction, and second diffusive particles having sub-micron dimensions, the second diffusive particles having a fourth index of refraction different from the third index of refraction so that, when the LEDs are illuminated, some light from the LEDs is scattered by the second diffusive particles by Mei scattering, causing the second diffusive dielectric layer to be diffusive to light emitted by the LED.

2. The structure of claim 1 wherein the first diffusive particles in the first diffusive dielectric layer comprise metal oxide particles.

3. The structure of claim 1 wherein the first diffusive particles in the first diffusive dielectric layer comprise polymer particles.

4. The structure of claim 1 wherein the LEDs are microscopic inorganic LEDs printed using an LED ink.

5. The structure of claim 1 wherein a thickness of the first diffusive dielectric layer is less than 100 microns and the particles in the dielectric layer are selected to provide a mean free path in the range of 0.05-0.3×dielectric layer thickness.

6. The structure of claim 1 wherein the second conductive layer comprises a mesh of silver nano-wires that are sintered together.

7. The structure of claim 1 wherein the first transparent binder in the first diffusive dielectric layer is the same material as the second transparent binder in the second diffusive dielectric layer.

8. The structure of claim 1 wherein the first diffusive particles in the first diffusive dielectric layer are the same material as the second diffusive particles in the second diffusive dielectric layer.

9. The structure of claim 1 wherein the first diffusive dielectric layer has a transmittance of greater than 70%.

10. The structure of claim 1 wherein the first conductive layer forms a surface of the substrate, and the LEDs are provided over the first conductive layer.

11. The structure of claim 1 wherein the second diffusive dielectric layer is formed overlying the substrate, wherein the second conductive layer is formed over the second diffusive dielectric layer, and wherein the LEDs are provided over the second conductive layer.

12. The structure of claim 11 wherein light from the LEDs exits through the second conductive layer and the substrate.

13. The structure of claim 1 wherein the first conductive layer allows light from the LEDs to pass through, the first conductive layer comprising silver nano-wires.

14. The structure of claim 1 wherein light exiting the second conductor layer is scattered off the second diffusive particles in the second diffusive dielectric layer within a near field region proximate to an interface between the second conductor layer and the second diffusive dielectric layer.

15. The structure of claim 1 further comprising a current conducted by the first conductive layer and the second conductive layer to illuminate the LEDs, wherein the first diffusive particles in the first diffusive dielectric layer reduce total internal reflection (TIR) in the dielectric layer, and the second diffusive particles in the second diffusive dielectric layer reduce TIR in the second conductive layer.

16. The structure of claim 1 wherein the structure forms a flexible light sheet.

17. A method performed by a light structure comprising:
emitting light from an array of vertical light emitting diodes (LEDs) provided over a substrate, the light being emitted from at least side surfaces of the LEDs and at least a top surface or bottom surface of the LED dies;
scattering light from the LEDs by a first diffusive dielectric layer formed around the LEDs, the first diffusive dielectric layer comprising a first transparent binder, having a first index of refraction, and first diffusive particles having sub-micron dimensions, the first diffusive particles having a second index of refraction different from the first index of refraction so that, when the LEDs are illuminated, some light from the LEDs is scattered by the first diffusive particles by Mei scattering, causing the first diffusive dielectric layer to be diffusive to light emitted by the LEDs;
passing light from the LEDs through a transparent conductor layer electrically contacting bottom or top electrodes of the LEDs;
scattering light from the LEDs passing though the transparent conductor layer by a second diffusive dielectric layer abutting the second conductive layer, the second diffusive dielectric layer comprising a second transparent binder, having a third index of refraction, and second diffusive particles having sub-micron dimensions, the second diffusive particles having a fourth index of refraction different from the third index of refraction so that, when the LEDs are illuminated, some light from the LEDs is scattered by the second diffusive particles by Mei scattering, causing the second diffusive dielectric layer to be diffusive to light emitted by the LED.

18. The method of claim 17 wherein the first transparent binder in the first diffusive dielectric layer is the same material as the second transparent binder in the second diffusive dielectric layer.

19. The method of claim 17 wherein the first diffusive particles in the first diffusive dielectric layer are the same material as the second diffusive particles in the second diffusive dielectric layer.

20. The method of claim 17 wherein light exiting the second conductor layer is scattered off the second diffusive particles in the second diffusive dielectric layer within a near field region proximate to an interface between the second conductor layer and the second diffusive dielectric layer.
